(19) United States
(12) Patent Application Publication
(10) Pub. No.: US 2009/0080955 A1
(43) Pub. Date: Mar. 26, 2009

(54) Content-changing document and method of producing same

(75) Inventors: Pinyen Lin, Rochester, NY (US); Kristine A. German, Webster, NY (US); Robert M. Lofthus, Webster, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION

(21) Appl. No.: 11/904,166

(22) Filed: Sep. 26, 2007

(51) Int. Cl. G03G 15/00

(52) U.S. Cl. 399/364

(57) ABSTRACT

Sheet print media are printed/marked with both transient and permanent marking which may be juxtaposed or the transient marking overprinted to change the meaning or message of text on the appearance of an image over time. Applications include advertising and labels for articles of commerce. The method applies to plain paper or coated print media for subsequent ultraviolet radiation.

### CROSS REFERENCE TO RELATED PATENTS AND APPLICATIONS

The following patents/applications, the disclosures of each being totally incorporated herein by reference are mentioned:

U.S. Publication No. US-2006-0067756-A1 (Attorney Docket No. 20031867Q-US-NP), filed Sep. 27, 2005, entitled “PRINTING SYSTEM,” by David G. Anderson, et al., and claiming priority to U.S. Provisional Patent Application Ser. No. 60/631,918 (Attorney Docket No. 20031867-US-PSP), filed Nov. 30, 2004, entitled “PRINTING SYSTEM WITH MULTIPLE OPERATIONS FOR FINAL APPEARANCE AND PERMANENCE,” and U.S. Provisional Patent Application Ser. No. 60/631,921, filed Nov. 30, 2004, entitled “PRINTING SYSTEM WITH MULTIPLE OPERATIONS FOR FINAL APPEARANCE AND PERMANENCE”;

U.S. Publication No. US-2006-0067757-A1 (Attorney Docket No. 20031867Q-US-NP), filed Sep. 27, 2005, entitled “PRINTING SYSTEM,” by David G. Anderson, et al., and claiming priority to U.S. Provisional Patent Application Ser. No. 60/631,918, Filed Nov. 30, 2004, entitled “PRINTING SYSTEM WITH MULTIPLE OPERATIONS FOR FINAL APPEARANCE AND PERMANENCE,” and U.S. Provisional Patent Application Ser. No. 60/631,921, filed Nov. 30, 2004, entitled “PRINTING SYSTEM WITH MULTIPLE OPERATIONS FOR FINAL APPEARANCE AND PERMANENCE”;

U.S. Publication No. US-2006-0115287-A1 (Attorney Docket No. 20040503-US-NP), Published Jun. 1, 2006, entitled “Glossing System For Use In A TIPP Architecture,” by Bryan J. Roof;

U.S. application Ser. No. 11/000,168 (Attorney Docket No. 20021985-US-NP), filed Nov. 30, 2004, entitled “Addressable Fusing and Heating Methods and Apparatus,” by David K. Biegelsen, et al.;

U.S. Publication No. US-2006-0115288-A1 (Attorney Docket No. 200405030-US-NP), Published Jun. 1, 2006, entitled “Glossing System For Use In A TIPP Architecture,” by Bryan J. Roof;

U.S. Publication No. US-2006-0132815-A1 (Attorney Docket 20040744-US-NP), Published Jun. 22, 2006, entitled “PRINTING SYSTEMS,” by Robert M. Lofthus, et al.;

U.S. Publication No. US-2006-0114313-A1 (Attorney Docket 20040448-US-NP), Published Jun. 1, 2006, entitled “PRINTING SYSTEM,” by Steven R. Moore;

U.S. Publication No. US-2006-0221362-A1 (Attorney Docket 20040676-US-NP), Published Oct. 5, 2006, entitled “PRINTING SYSTEM,” by Paul C. Julien;

U.S. Publication No. US-2006-0222393-A1 (Attorney Docket 20040971-US-NP), Published Oct. 5, 2006, entitled “PRINTING SYSTEM,” by Jeremy C. deJong, et al.;

U.S. Publication No. US-2006-0238778-A1 (Attorney Docket 20040704-US-NP), Published Oct. 26, 2006, entitled “PRINTING SYSTEMS,” by Michael C. Mongeon, et al.;

U.S. Publication No. US-2006-0269310-A1 (Attorney Docket 20040649-US-NP), Published Nov. 30, 2006, entitled “PRINTING SYSTEMS,” by Kristine A. German, et al.;

U.S. Publication No. US-2006-0268318-A1 (Attorney Docket 20050281-US-NP), Published Nov. 30, 2006, entitled “PRINTING SYSTEM,” by Robert M. Lofthus, et al.;

U.S. Publication No. US-2006-0268317-A1 (Attorney Docket 20050382-US-NP), Published Nov. 30, 2006, entitled “SCHEDULING SYSTEM,” by Robert M. Lofthus, et al.;

U.S. Publication No. US-2006-0066885-A1 (Attorney Docket A3546-US-CIP), filed May 25, 2005, entitled “PRINTING SYSTEM,” by David G. Anderson, et al.;

U.S. application Ser. No. 11/166,299 (Attorney Docket 20041110-US-NP), filed Jun. 24, 2005, entitled “PRINTING SYSTEM,” by Steven R. Moore;

U.S. Publication No. US-2007-0024894-A1 (Attorney Docket 20041111-US-NP), Published Feb. 1, 2007, entitled “PRINTING SYSTEM,” by Steven R. Moore, et al.;

U.S. application Ser. No. 11/215,791 (Attorney Docket 2005077-US-NP), filed Aug. 30, 2005, entitled “CONSUMABLE SELECTION IN A PRINTING SYSTEM,” by Eric Hamby, et al.;

U.S. application Ser. No. 11/234,468 (Attorney Docket 20050262-US-NP), filed Sep. 23, 2005, entitled “PRINTING SYSTEM,” by Eric Hamby, et al.;

U.S. Publication No. US-2007-0081828-A1 (Attorney Docket 20031549-US-NP), Published Apr. 12, 2007, entitled “PRINTING SYSTEM WITH BALANCED CONSUMABLE USAGE,” by Charles Radulski, et al.;

U.S. Publication No. 20051103-US-NP (Attorney Docket 20051103-US-NP), Published May 31, 2007, entitled “PRINTING SYSTEM,” by David A. Mueller; and,

U.S. application Ser. No. 11/317,167 (Attorney Docket 20050823-US-NP), filed Dec. 23, 2005, entitled “PRINTING SYSTEM,” by Robert M. Lofthus, et al.

### BACKGROUND

The present disclosure relates to a technique or process of printing documents on print media and particularly digital printing on print media in sheet form in which some of the marking on the print media is transient or changes over an interval of time. Heretofore, many marking compositions have been employed which faded or disappeared over time and have spawned the expression “disappearing ink.” Also, it is known that certain chemical compositions for the marking will darken upon exposure to radiation in a limited frequency band such as, for example, radiation in the ultraviolet spectrum. Furthermore, it has been known to provide a coating on the surface of the print media which darkened or changed upon exposure to ultraviolet radiation and coatings which responded to heat or infrared radiation to darken. The primary purpose of such transient printing was either to eliminate the content of the document over time for security or privacy reasons or to enable the print media to be reused for printing.

The aforesaid techniques for transient printing have been treated substantially as novelties in the commercial marketplace and have found primary applicability in the arena of document security applications.

### BRIEF DESCRIPTION

The present disclosure describes a method or technique of printing on sheet print media in which some of the marking is transient over time. A portion of the image on a side of the print media sheet is printed with marking of transient nature over time; and, other portions of the image on the same side of the print media sheet are printed with permanent marking. Thus, the appearance or meaning, depending upon whether the transient portion is graphic or textual, changes over time. This is commercially significant where the change is in the nature of the meaning of text; or, in the case of graphic images, the very nature of the image presented. In one version of the disclosed method, the transient marking may be applied along with permanent marking on a label to be affixed to an article of commerce. The transient marking may thus change the meaning of the label over time, such as instructions for use of the product to which the label is affixed or warnings as to changes in the condition over time of the article to which the label is affixed.

In another version of the disclosed method, the transient marking and the permanent marking are mutually overprinted, such that, upon change of the transient marking, different aspects of the permanent marking are exposed to view. The method of the present disclosure has applicability for the intended purpose of changing the appearance or meaning of the marking on the print media.

In another version of the method, coated paper sensitive to color change upon exposure to ultraviolet radiation (U.V.) may be employed in which the desired transient portion is marked by exposure to U.V.; and, the permanent marking performed by another print engine such as an ink jet printer or electrostatic printer.

In another version of the method, the portion of the image marked in the transient printing may include segments of transient printing with different time intervals for sequential disappearance. The version of the method employing transient marking segments with different time intervals may also be applied for printing labels for use on articles of manufacture.

In another version of the method, the transient portion of the image may comprise meta tags. In still another version of the method, the transient portion may comprise half tone marking; and, the permanent portion may also comprise half tone marking.

### BRIEF DESCRIPTION OF THE DRAWINGS

FIG. 1 is a block flow diagram of the method as practiced with plain paper print media;

FIG. 2 is a block flow diagram of the method as practiced with coated print media; and,

FIG. 3 is a block flow diagram of the user inputs of the versions of FIGS. 1 and 2.

### DETAILED DESCRIPTION

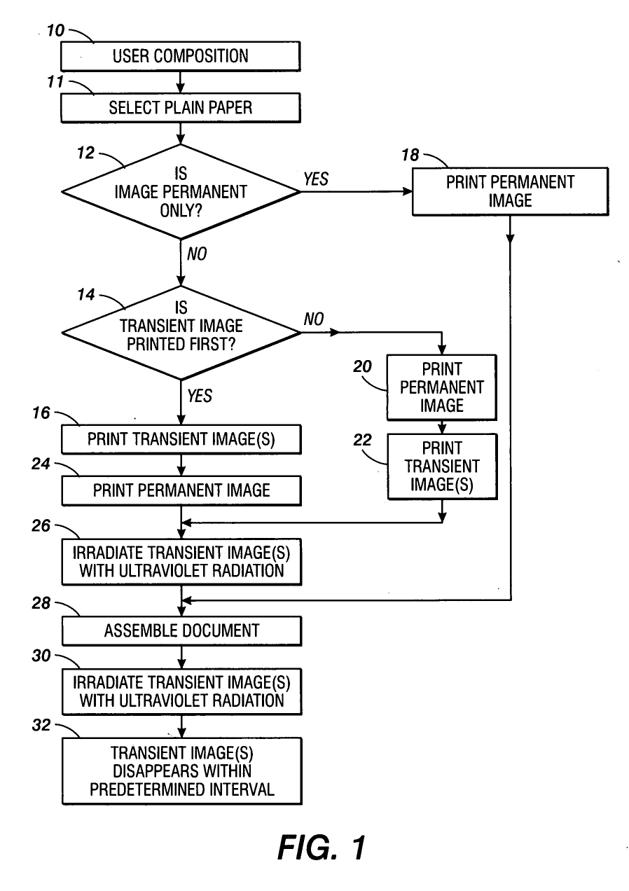

Referring to FIG. 1, the method is exemplified for printing on plain paper, where the user input to the print engine system is indicated at 10 where the user inputs information relating to the image composition, including transient interval(s) and which may include over printing. The user then proceeds to step 11 and selects plain paper as the print media. The method then proceeds at step 12 to inquire as to whether the image to be printed is to be permanent marking only. If the determination at step 12 is negative, the method proceeds to step 14 where the inquiry is made as to whether a transient image is to be printed first. If the inquiry in step 14 is answered in the affirmative, the transient image is printed at step 16 on the plain paper.

However, if the determination at step 12 was affirmative, the method proceeds to step 18 and the image is permanently marked. If the determination in step 14 is negative, the system proceeds to print the permanent image at step 20 and then proceeds to print the transient image at step 22.

Alternatively, following the printing of the transient image at step 16, the system proceeds to print the permanent image at step 24. The transient marking of steps 16 and 22 may include marking the material that changes color over time by virtue of the composition of the marking.

Subsequently, the printed images from either steps 24 or 22 have their exposed transient marking irradiated with ultraviolet radiation at step 26 to effect the desired changes in the transient image. The printed images from steps 26, 18 may then be assembled to form a document at step 28 and distributed to the end user at step 30. Upon lapse of the predetermined time interval the transient image disappears as indicated at step 32.

The present disclosure also includes the arrangement in which the transient marking is performed in segments wherein each segment is marked with material which disappears in a different interval, thus giving the printed image a sequentially changing appearance over time. If this latter version is employed, the transient marking would be accomplished by printing the individual segments on different e.g. plural print engines. The transient marking may also include meta-tags. The transient marking may include half tone marking; and, the permanent marking may individually or in combination therewith include half tone marking.

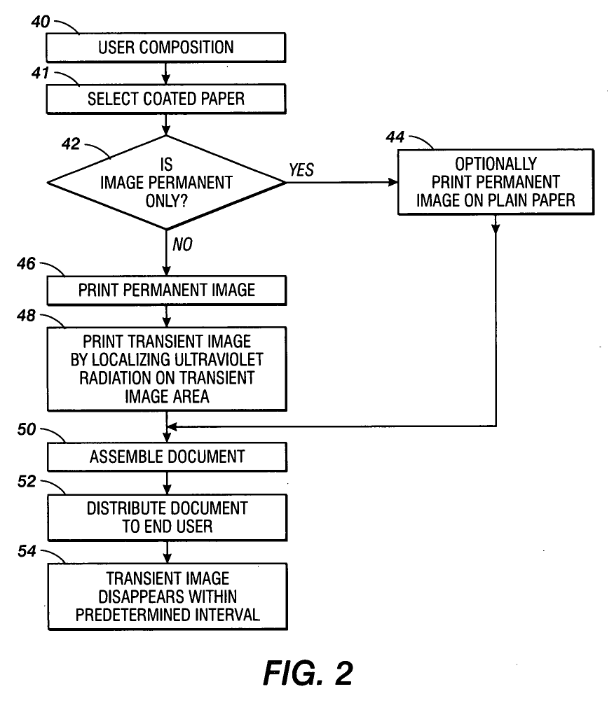

Referring to FIG. 2, another version of the method of the present disclosure is illustrated wherein a user input at step 40 determines the composition, including transient interval(s), over printing, if any, and proceeds to step 41 and selects printing from coated paper. For example, paper coated with transparent dye which is operative to turn opaque upon exposure to ultraviolet radiation may be employed. Upon completion of the user inputs at step 40, 41, the method proceeds to step 42 and inquires as to whether the image is to be permanently marked only. If the query at step 42 is answered in the affirmative, the method proceeds to step 44 and optionally prints the permanent image on plain paper.

If, however, the query at step 42 is answered in the negative, the method proceeds to step 46 and prints the permanent image on the coated paper. The method then proceeds to step 48 and prints the transient image by localizing ultraviolet radiation on a transient image area at step 48.

The method then proceeds from either step 48 or step 44 to step 50 where the document is assembled; and, at step 52 the assembled document is distributed to the end user. The transient image then disappears within the predetermined time interval as indicated at step 54 to provide the desired effect on the printed image.

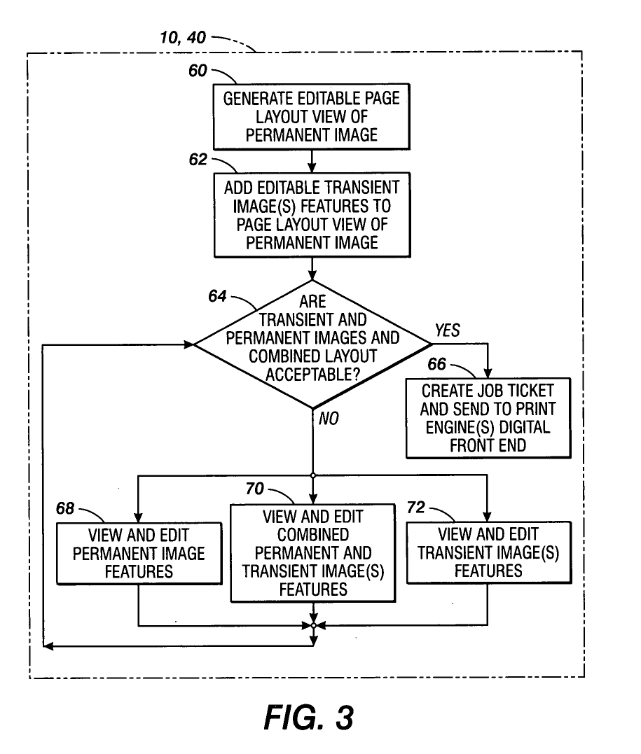

Referring to FIG. 3, block flow diagram of the user composition steps 10, 40 of the method of FIGS. 1 and 2 is presented wherein at step 60 the method which may be software driven enables the user to generate an editable page layout view of the image to be permanently marked. The method then proceeds to step 62 and enables the user to add editable transient image(s) features to a page layout view of the image to be permanently marked. The method then proceeds to step 64 and inquires as to whether the layout of the combined transient and permanent images is acceptable. The combined image may include over printing of one of the transient and permanent marking with respect to the other. If the query in step 64 is answered in the affirmative, the method proceeds to step 66 and creates a print job ticket or order and sends the job to the digital front end (DFE) of one or more print engines. For example, the transient marking may be accomplished on one print engine; and, the permanent marking on another print engine.

If the version of the presently disclosed method utilizing segments of the transient image changing over different intervals is employed, these different segments of the transient image may also be marked on different print engines. The print engine may also be of the electrostatic or ink jet type. If the query in step 64 is answered in the negative the program proceeds concurrently to steps 68, 70 and 72 where respectively the permanent image features, the combined permanent and transient image features and the transient image(s) features are viewed and edited. Upon completion of the user editing at steps 68, 70, 72 the program returns to step 64.

The result of the disappearing transient image may produce either a change in color, a change in the writing or meaning of textural information, or may change the visual appearance of an image, either by elimination of portions thereof or by eliminating a characteristic such as color from overprinting. The permanent marking may be a first color and the transient marking changing to a different color over a predetermined time interval.

The second portion of transient marking may also contain codes such as, for example, scrambling, bar codes and graph codes which are transient over a predetermined time interval. The second portion of transient marking may also be effective to disappear and reappear after a predetermined time.

In plain paper media the transient coating may be made by the ultraviolet sensitive marking followed by ultraviolet radiation exposure. The predetermined time intervals for the transient images can be varied by changing the ultraviolet sensitive marking such as materials and quantity and/or by changing the level of the ultraviolet radiation exposure such as time and intensity. On coated media, the transient marking may be by ultraviolet laser from one print engine; and, the permanent marking applied from another print engine.

The version of the presently disclosed method employing segments of the transient image changing over different time intervals may be employed with coated papers by providing different coating in selected regions or areas of the coated print media. However, this latter version results in a significant increase in the cost of the coated print media and is thus viewed as more limited to images having a standardized format thereby enabling the specially segmented coated print media to be manufactured in sufficient quantity to result in less costly media.

The method of the present disclosure thus enables the change in communication of information or the meaning or appearance of images over time by the process of the printing on the print media. This presently disclosed method may be practiced on one side of the print media sheet; or, the transient marking may be performed on the side of the sheet opposite the permanent marking; or, combinations of either may be performed with respect to the front and back sides of the print media sheet. Combinations of transient and permanent marking may also be applied to labels for articles of manufacture where the information thereon is desired to change over time.

Both permanent and transient images can be digitized into half tone. The arrangement of both half tone images includes juxtaposing the permanent and the transient portions.

The present disclosure thus describes a method of transient printing and which alters the conveyance or communication of information or images on sheet print media including labels over a predetermined time for serving the purpose of changing the information conveyed by the print media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of printing on print media intended to change appearance over a predetermined interval comprising:
(a) printing a first portion of an image with permanent image marking;
(b) printing a second portion of the image with image marking which is transient over a predetermined time interval; and,
(c) arranging the first and second portions such that upon disappearance of the marking of the second portion, a desired appearance of the first portion remains.

2. The method defined in claim 1, wherein the step of printing a second portion includes over-printing said first portion.

3. The method defined in claim 1, wherein the step of arranging includes juxtaposing the first and second portions.

4. The method defined in claim 1, wherein the step of printing a second portion includes coating the print media with a radiation sensitive coating and exposing the coating to ultraviolet radiation.

5. The method defined in claim 4, wherein the step of printing a second portion includes exposing the coating to localized ultraviolet radiation.

6. The method defined in claim 1, wherein the step of printing a first portion includes permanent marking on plain paper; and, the step of printing a second portion includes marking on the plain paper with material responsive to ultraviolet radiation to produce the transient image.

7. The method defined in claim 1, wherein the step of printing a second portion includes marking which is transient at plural predetermined different time intervals.

8. The method defined in claim 1, wherein the step of printing a second portion is performed subsequently to printing said first portion.

9. The method defined in claim 1, wherein the step of printing a second portion is performed concurrently with the printing of the first portion.

10. The method defined in claim 1, wherein the step of printing a first portion includes printing electrostatically.

11. The method defined in claim 1, wherein the step of printing a first portion includes ink-jet printing.

12. The method defined in claim 1, wherein the step of printing a first portion includes printing with a first color; and, the step of printing a second portion includes printing with a second color.

13. The method defined in claim 12, wherein the step of printing with a second color includes over printing the first color.

14. The method defined in claim 1, wherein the step of printing the second portion includes coating the print media on at least one side with coating sensitive to radiation and marking an image with localized ultraviolet radiation.

15. The method defined in claim 14, wherein the step of coating includes coating with a dye sensitive to ultraviolet radiation which changes from transparent to opaque upon exposure to the ultraviolet radiation.

16. The method defined in claim 14, wherein the step of printing the second portion includes coating both sides of the print media with transparent dye operative to turn opaque upon localized exposure to ultraviolet radiation.

17. The method defined in claim 1, wherein the step of printing a second portion includes marking with a transparent dye which becomes opaque upon exposure to ultraviolet radiation.

18. The method defined in claim 17, wherein the step of marking includes dispensing the dye from an ink-jet device.

19. The method defined in claim 18, wherein the step of dispensing includes irradiating with ultraviolet radiation at discharge from the ink-jet device.

20. The method defined in claim 1, wherein the step of printing the second portion includes marking in a digital print engine with transparent dye which becomes opaque upon exposure to ultraviolet radiation.

21. The method defined in claim 20, wherein the step of marking includes irradiating the dye with ultraviolet radiation in the print engine.

22. The method defined in claim 1, wherein the step of printing a second portion includes image marking which reappears after a predetermined time.

23. The method defined in claim 1, wherein the step of printing a second portion includes image marking which reappears upon exposure to ultraviolet radiation.

24. The method defined in claim 1, further comprising performing the step of printing the first permanent image and the step of printing the second transient images on different sides of the print media.

25. The method defined in claim 1, wherein the step of printing a second portion includes printing codes from one of scrambling, bar codes and graph codes.

26. The method defined in claim 1, wherein the step of printing a second portion includes printing meta tags.

27. The method defined in claim 1, wherein the step of printing a first portion includes printing a half tone.

28. The method defined in claim 1, wherein the step of printing a second portion includes printing a half tone.

29. A method of printing on plain paper in which the image printed changes over a predetermined time interval comprising:
(a) initially marking a first portion of an image on a side of the paper with a permanent marker; and,
(b) subsequently marking a second portion of an image on the side with an image which is transient over the predetermined time interval.

30. The method defined in claim 29, wherein the step of subsequently marking includes over marking the first portion of the image.

31. A method of printing on plain paper intended to change over a predetermined time interval comprising:
(a) initially marking a first portion of an image on a side of the paper with a marker transient over the predetermined time interval; and,
(b) subsequently marking a second portion of an image on the side with a permanent marker.

32. A method of labeling an article with a time critical message comprising:
(a) marking a first message on a label with permanent marking;
(b) marking a second time critical message on a label with marking which is transient over a predetermined time interval; and,
(c) disposing the label with the article.

33. The method defined in claim 32, wherein the step of marking a second time critical message includes marking the label with material transient in a plurality of predetermined different time intervals.

34. The method defined in claim 33, wherein the step of marking with material which is transient in different time intervals includes marking with a plurality of messages.

35. The method defined in claim 34, wherein the step of marking which is transient in different time intervals includes marking with plural image marking engines.

36. A method of printing on a coated print media intended to change over a predetermined interval comprising:
(a) initially marking a first portion of an image with marking material which changes color upon exposure to ultraviolet radiation upon a side of the media; and,
(b) subsequently marking a second portion of an image on the side with a permanent marker.

37. The method defined in claim 36, wherein the step of initially marking includes marking with a material for which the color changes over a predetermined time interval.

38. The method defined in claim 36, wherein the step of initially marking a first portion of an image includes marking with a first print engine; and, the step of subsequently marking includes marking with a second print engine.

39. The method defined in claim 36, wherein the step of subsequently marking a second portion includes marking with one of an ink jet or an electrostatic print engine.

40. A method of printing on a coated print media intended to change over a predetermined interval comprising:
(a) initially marking a first portion of an image with a permanent marker; and,
(b) subsequently marking a second portion of an image with marking material which changes color upon exposure to ultraviolet radiation.

41. The method defined in claim 40, wherein the step of initially marking a first portion of an image includes marking with a first print engine; and, the step of subsequently marking includes marking with a second print engine.

42. The method defined in claim 40, wherein the step of initially marking a first portion includes marking with one of an ink jet and an electrostatic print engine.
